(19) United States
(12) Patent Application Publication
(10) Pub. No.: US 2007/0175076 A1
(43) Pub. Date: Aug. 2, 2007

(54) Indicia displaying interior rearview mirror device

(76) Inventor: James Calvin Stanley, Visalia, CA (US)

Correspondence Address: ROBERT Z. EVORA, 4741 PLANTERS WALK, DOUGLASVILLE, GA, 30135, US

(21) Appl. No.: 11/545,410

(22) Filed: Oct. 10, 2006

Related U.S. Application Data
(60) Provisional application No. 60/763,433, filed on Jan. 30, 2006.
(60) Provisional application No. 60/816,273, filed on Jun. 23, 2006.

(51) Int. Cl. G09F 21/04

(52) U.S. Cl. 40/593

(57) ABSTRACT

An indicia displaying interior rearview mirror device including a fastener to secure the rearview mirror device to a bracket of a interior rearview mirror. The rearview mirror device includes a display panel on which indicia may be displayed and a air freshener may be housed. The rearview mirror device may be oriented in a variety of different positions for viewing.

### CROSS REFERENCE TO RELATED APPLICATIONS

This application is a Non-Provisional Application which claims the benefit of the filing date of U.S. Provisional Application Ser. No. 60/763,433, entitled “ATTACHMENT FOR AN INTERIOR REARVIEW MIRROR OF A VEHICLE” filed Jan. 30, 2006, the entirety of which is incorporated herein by reference. This application also claims the benefit of the filing date of U.S. Provisional Application Ser. No. 60/816,273, entitled “INDICIA DISPLAYING INTERIOR REARVIEW MIRROR DEVICE” filed Jun. 23, 2006, the entirety of which is also incorporated herein by reference.

### BACKGROUND OF THE INVENTION

1. Field of the Invention

The present invention relates in general to providing an interior vehicle rearview mirror device for displaying indicia and for providing a fragrance to the interior of the vehicle.

2. Description of the Related Art

Conventionally, decals having indicia are placed in the corner of a vehicle window so as to prevent the illegal obstruction of a drivers view. The indicia may include a favorite school, motto, vocal band, a professional athletic team, a branch of military, a mascot, a brand, a logo or any other type of desired label displayed by the owner of the vehicle. Traditionally, these decals provided no additional air freshening function and were merely used as an indicia displaying sticker.

### SUMMARY OF THE INVENTION

An object of the present invention is to provide an interior vehicle rearview mirror device that includes a decal to the interior vehicle rearview mirror for forward facing display of preferred indicia.

The interior vehicle rearview mirror device may be designed to include an air freshener to sanitize the air and/or simply refresh the surrounding area of an undesirable order.

In one embodiment, the rearview mirror device includes a display panel fastened via a linkage to a rearview mirror. At least one side of the display panel includes forward facing indicia being displayed thereon. The linkage includes at least one positioning device, a link and a fastener that adjustably fastens to a rear view mirror bracket.

According to another aspect of this invention, the interior vehicle rearview mirror device attaches to the back surface of an interior rearview mirror. By attaching the interior vehicle rearview mirror device to the behind the interior rearview view mirror, the driver's angle of view is minimized by obstructions.

Another object of the invention is to provide an interior vehicle rearview mirror device including a flat elongated base having a front surface and a back surface. The back surface is attached to a forward facing portion of a rearview mirror and wherein the front surface includes forward facing indicia being displayed thereon.

The indicia may include a trademark, a service mark, a name, a logo, an emblem or the like. The flat elongate base of the interior vehicle rearview mirror device is a material composed of at least one of a polymer, a paper, and rubber, and the like.

Yet another aspect of the invention is to provide an interior vehicle rearview mirror device including a flat elongated base having a front surface and a back surface. The back surface is attached to a forward facing portion of a rearview mirror and the front surface includes forward facing indicia being displayed thereon. An adjustable attachment is provided for attaching the flat elongated base to the forward facing portion of the rearview mirror. The adjustable attachment includes at least one fastener connected to the flat elongated base.

The fastener of the adjustable attachment may have a peripheral end that includes a hook that fastens to an outer edge of the interior rearview mirror.

A further object of this invention is to include a flat elongated base embedded with an access element. The flat elongated base includes a front surface and a back surface. The back surface is attached to a forward facing portion of a rearview mirror. The front surface includes forward facing indicia being displayed thereon. The embedded access element may be selected from at least one of: a magnetic strip, a bar code, an RF element, a near field technology element and a transponder.

The embedded access element may be used to allow a user access into a particular area, such as a parking lot or a seat at a sporting event, a mall, and/or any other place that requires special access.

These and other objects, features, and/or advantages may accrue from various aspects of embodiments of the present invention, as described in more detail below.

### BRIEF DESCRIPTION OF THE DRAWINGS

Various exemplary embodiments of this invention will be described in detail, wherein like reference numerals refer to identical or similar components or steps, with reference to the following figures.

FIG. 1 is a side view of an interior vehicle rearview mirror device secured to an interior rearview mirror according to this invention.

FIG. 2 is a back side view of the interior rearview mirror device connected to the interior rearview mirror and oriented to display indicia according to this invention.

FIG. 3 is a side view of an interior vehicle rearview mirror device secured to an interior rearview mirror in a second orientation according to this invention.

FIG. 4 is a back side view of the interior rearview mirror device connected to the interior rearview mirror and positioned in the second orientation to display indicia according to this invention.

FIG. 5 is a side view of an interior vehicle rearview mirror device secured to an interior rearview mirror according to a third embodiment of this invention.

FIGS. 6 and 7 illustrate various exemplary configurations for a display panel according to this invention.

FIG. 8 illustrates an exemplary configuration for a hook fastener of the rearview mirror device according to this invention.

FIGS. 9A, 9B, 10A, 10B, 11A, 11B, 11C, 11D, 11E and 11F illustrate various exemplary configurations for a hook fastener of the rearview mirror device according to this invention.

FIGS. 12 and 13 illustrate a fourth embodiment for attaching an interior vehicle rearview mirror device to an interior rearview mirror according to this invention.

FIGS. 14 and 15 illustrate a fifth embodiment for attaching an interior vehicle rearview mirror device to an interior rearview mirror according to this invention.

FIG. 16 illustrates one embodiment for a catch according to this invention.

FIG. 17 illustrates a sixth embodiment for attaching an interior vehicle rearview mirror device to an interior rearview mirror according to this invention.

FIGS. 18 and 19 illustrate a seventh embodiment for attaching an interior vehicle rearview mirror device to an interior rearview mirror according to this invention.

FIGS. 20 and 21 illustrate an interior vehicle rearview mirror device for displaying indicia embedded with an access element in accordance with this invention.

FIG. 22 illustrates an air freshener display panel in accordance with this invention.

FIG. 23 illustrates the perforations in the air freshener display panel in accordance with this invention.

FIG. 24 illustrates a detachable display panel in the rearview mirror device in accordance with this invention.

### DETAILED DESCRIPTION OF EXEMPLARY EMBODIMENTS

Particular embodiments of the present invention will now be described in greater detail with reference to the interior rearview mirror devices 10, 100 shown in the attached figures. The objects and features of the invention are interchangeable and applicable to the various embodiments of the interior rearview mirror devices 10,100 described herein.

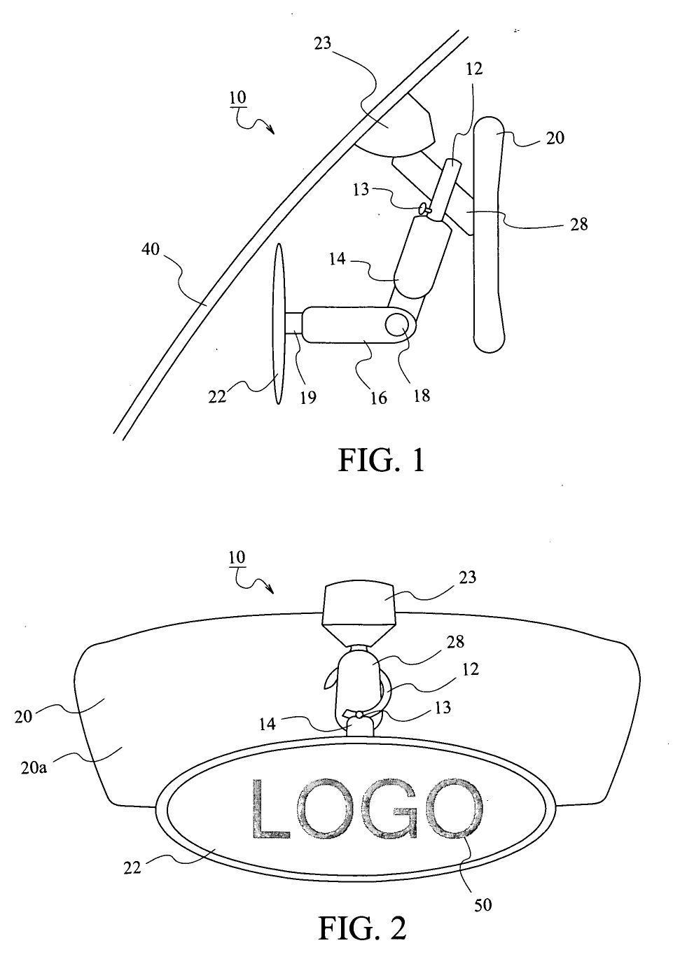

FIG. 1 illustrates a side view of an interior rearview mirror device 10 attached to a rearview mirror bracket 28 of an interior rearview mirror 20. The rearview mirror bracket 28 is attached by a base 23 to a windshield 40 of a vehicle.

According to this exemplary embodiment, the interior rearview mirror device 10 includes a fastener 12, a first link 14 connected to a second link 16 through a first positioning device 18. The second link 16 is connected to a display panel 22 by a second positioning device 19.

FIG. 2 illustrates a back view of the interior rearview mirror device 10 secured by the fastener 12 to the rearview mirror bracket 28 of the interior rearview mirror 20 and oriented to display indicia 50 according to this invention.

The display panel 22 of the interior rearview mirror device 10 may be generally shaped to conform within the back side shape of the interior rear view mirror 20 so that the driver's view is not substantially obstructed by the rearview mirror device 10. Various shapes, sizes and colors for the rearview mirror device 10 are contemplated within the features and objects of this invention and will be discussed later.

In operation, the fastener 12 of the interior rearview mirror device 10 is secured to the rearview mirror bracket 28 between the interior rearview mirror 20 and the windshield 40. The fastener 12 may be secured to the rearview mirror bracket 28 by a locking device 13. The locking device 13 may be selected from any number of securing mechanisms, including but not limited to, a screw, a releasable locking pin, a ratchet and teeth mechanism, and the like.

Referring back to FIG. 1, the first positioning device 18 and the second positioning device 19 may be configured as any one of, or combination of, various positioning mechanisms. For example, the positioning mechanisms 18, 19 may include a pivot, a telescopic extension, a swivel, a universal joint, and/or any other desired movement for optimally positioning the display panel 22 in any preferred orientation. In the alternative, it is also possible to incorporate another positioning device element (not shown) between the fastener 12 and the first link 14 including the positioning mechanism characteristics noted above.

According to this exemplary embodiment, the first positioning device 18 is a pivot joint that allows the second link 16 to be radially pivoted relative to the first link 14 into a desired orientation. It is also possible to allow the first positioning device 18 to adjust in any other preferred orientation. Likewise, in this embodiment, the second positioning device 19 is a telescoping joint that allows the display panel 22 to be extended closer to, or retracted from, the windshield 40 into a desired orientation. Similarly, it is understood that the second positioning device 19 may include other adjustable features and/or functions, such as including a universal joint so that the display panel can pivot, rotate, extend and retract all at the same time.

Although the interior rearview mirror device 10 is shown as a linkage unit including various components parts, it is to be understood that the interior rearview mirror device 10 may be made with fewer (or more) parts functionally performing the same display positioning adjustments. For example, by employing a flexible material, the interior rearview mirror device 10 may be made as a single integral piece and may be flexibly contorted into a variety of preferred positions for displaying the indicia 50.

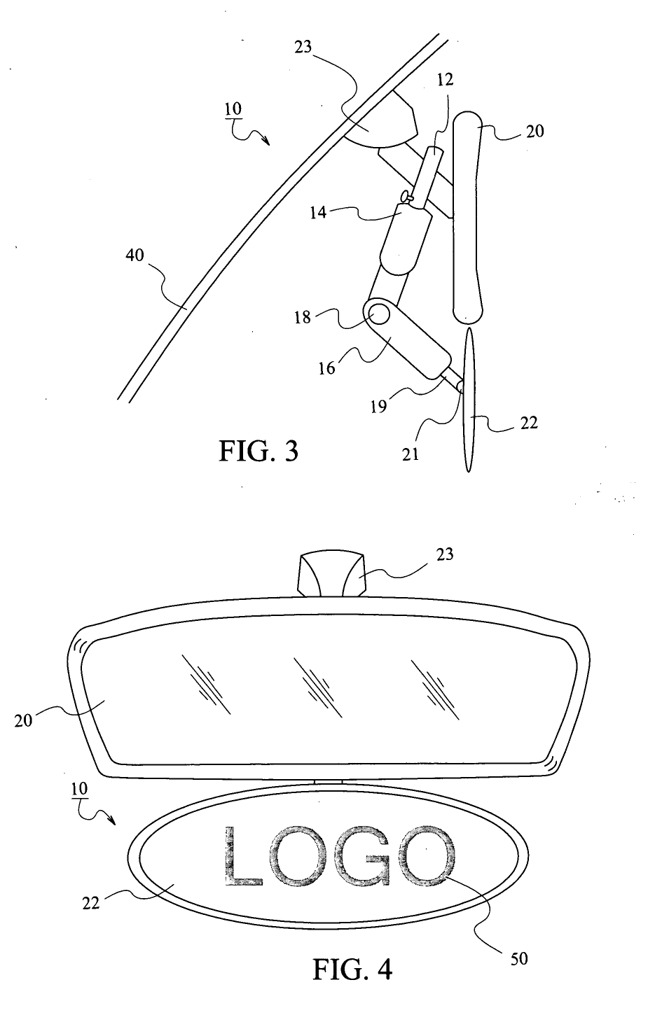

FIGS. 3 and 4 demonstrate the versatility of the rearview mirror device 10 for displaying the indicia 50. According to this configuration, the first positioning device 18 is swiveled so that the display panel 22 may be disposed to orient the indicia 50 facing into the cabin of the vehicle.

In contrast to FIG. 1, the first positioning device 18 of the rearview mirror device 10 shown in FIG. 3 is rotated approximately 120 degrees counterclockwise so that the display panel 22 faces backward into the cabin of the vehicle. FIG. 3 shows the second positioning device 19 including a ball joint 21 for positioning the display panel 22 in an optimal position which may lie just below the interior rearview mirror 20 as shown in FIG. 4. An advantage of the rearview mirror device 10 is the versatility in positioning the display panel 22 in any preferred position as shown in FIGS. 3 and 4.

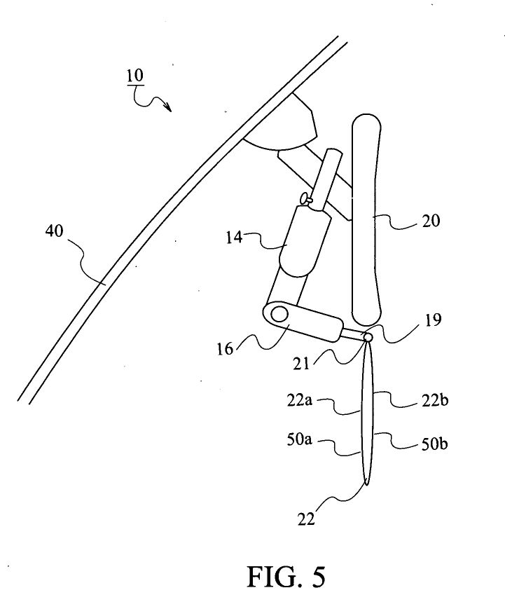

FIG. 5 is a side view of the rearview mirror device 10 secured to an interior rearview mirror according to an alternative embodiment of this invention. The object of this embodiment is to allow both, the front side 22a and back side 22b of the display panel 22 to be used to display indicia 50a, 50b. As such, the user may have the choice of choosing from at least two different indicia 50a, 50b and two different sides to display on the display panel 22. Either side 22a, 22b of the display panel 22 may be positioned into, and away from, the interior cabin of the vehicle.

In particular, the ball joint 21 of the second positioning device 19 may be used to swivel the position of the display panel 22 so that the front side 22a and the back side 22b of the display panel 22 can be rotated to display either one of the indicia 50a, 50b forward. Likewise, the display panel 22 may be rotated so that the position of the front side 22a and the back side 22b of the display panel 22 may be alternated as desired.

The second link 16 may be attached via the ball joint 21 of the second positioning device 19 to the display panel 22 at any position on the display panel display panel 22. For example, FIG. 5 shows the ball joint 21 connected to the display panel 22 at an uppermost edge as shown in FIG. 5. Alternatively, the ball joint 21 may have been connected to the display panel 22 at a lower edge (not shown) of the display panel 22.

Various materials may be used as the composition for the interior rearview mirror devices 10, 100. For example, a metal, a polymer, a rubber, a plastic, a vinyl, cloth, a moldable material, a paper product and/or any other material, now known or later discovered, may be used to make up the composition of the interior rearview mirror device 10.

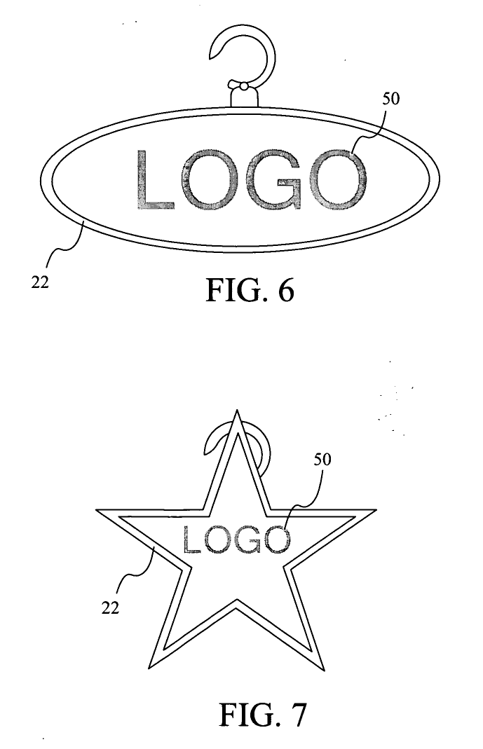

FIGS. 6 and 7 show, as mentioned previously, that the indicia 50 and/or the display panel 22 of the interior rearview mirror device 10 may be composed of a variety of different shapes, colors and sizes. FIG. 6 shows the display panel 22 and the indicia 50 being constructed oval and oblong in configuration. Likewise, FIG. 7 further demonstrates that any size and shape (for example, a star shape display panel 22 including indicia 50) may be chosen in accordance with this invention. As shown herein, the indicia 50 and/or the display panel 22 may take any desired shape, including but not limited to, circles, rectangles, squares, triangles, trademark designs, a logo, a brand, a mascot, and/or any obtuse shape, design or printed indicia in accordance with this invention.

Referring again to FIG. 5, the display panel 22 may be opaque and/or may be made of a translucent material to display the indicia 50, 50a, 50b there-through. The indicia 50, 50a, 50b may be affixed onto either side 22a, 22b of the display panel 22 in a variety of different ways. For example, the indicia 50 may be silk-screened or formed directly into the interior rearview mirror device 10 and/or adhered thereto in any number of plausible ways now known or later developed. Alternatively, the indicia 50 may be embedded within a translucent display panel allowing visibility from both sides of the display panel 22. The indicia 50 may include, for example, a trademark, a service mark, a name, an emblem, a logo, a banner, an advertisement and/or any other type of indicia. The user can place indicia 50 to support their favorite business, university, school, local establishment, military, hobbies, and the like.

The indicia 50 may be attached to display panel 22 in a variety of different ways. One method would be to provide an adhesive to the back side of the indicia 50 that lies adjacent to the display panel 22. The adhesive may be glue, a polymer, rubber, cement, a translucent adhesive, Velcro, and/or any other type of material used for providing adhesion from one surface to another within the scope of this invention.

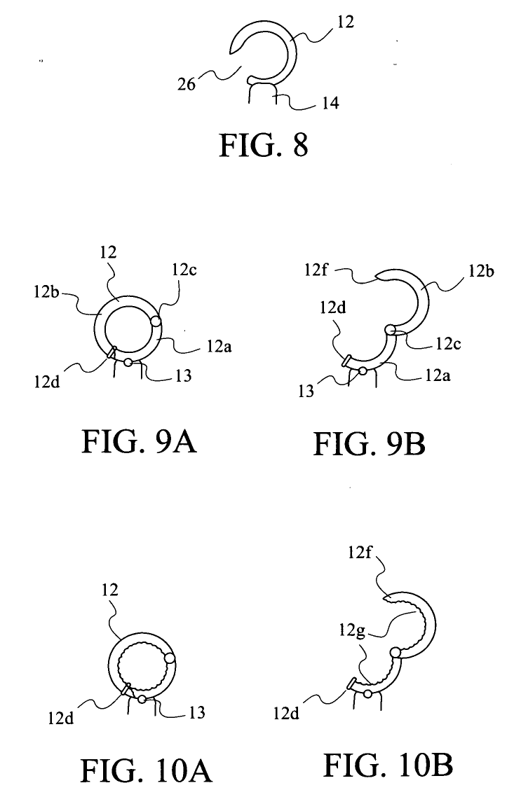

FIGS. 8, 9A, 9B, 10A, 10B, 11A, 11B, 11C and 11D demonstrate various methods for securing the fastener 12 to the rearview mirror bracket 28 of the interior rearview mirror 20. In FIG. 8, the fastener 12 includes a wide-mouth opening 26 for receiving the rearview mirror bracket 28 of the interior rearview mirror 20. The fastener 12 may be made of a flexible material so that the opening 15 may flexibly manipulated to surround and secure the rearview mirror device 10 to the rearview mirror bracket 28.

FIGS. 9A and 9B illustrate another embodiment for fastening the rearview mirror device 10 to the rearview mirror bracket 28. The fastener 12 includes a first fastener portion 12a and a second fastener portion 12b that pivots about a pivot 12c. In a closed and secure position, a fastener end portion 12f of the second fastener portion 12b is secured by a fastener captivating portion 12d as shown in FIG. 9A. The fastener end portion 12f may be secured to the fastener captivating portion 12d in plurality of different ways.

FIGS. 10A and 10B illustrate another embodiment for fastening the rearview mirror device 10 to the rearview mirror bracket 28. According to this exemplary embodiment, the fastener end portion 12f is secured to the fastener captivating portion 12d via a ratchet and teeth locking mechanism. Similar to that used in hand-cuffs used by law enforcement. The ratchet and teeth locking mechanism such as the gripping surface 12g shown in FIG. 10A, is employed to allow the fastener end portion 12f of the fastener 12 to be variably positioned so that the opening 26 may be incrementally sized to fit around various size rearview mirror brackets 28. The fastener end portion 12f of the fastener 12 is captivated by the fastener captivating portion 12d that includes a ratchet and teeth locking mechanism. The ratchet and teeth locking mechanism may be integrally disposed on either the inner (as shown in FIG. 10A and 10B) or outer surface (not shown) of the fastener 12.

To release the fastener 12, the locking device 13 is engaged and the fastener end portion 12f is released from the fastener captivating portion 12d as shown in FIG. 9B. Likewise, in the embodiment shown in FIG. 10A and 10B, when the locking device 13 is engaged, the ratchet and teeth locking mechanism on the fastener 12 is disengaged and the fastener end portion can be released from the locking device 13.

Alternatively, FIGS. 10A and 10B illustrate another embodiment for fastening the rearview mirror device 10 to the rearview mirror bracket 28. An interior portion of the fastener 12 may include a gripping surface 12g. The gripping surface 12g may be integral with the construction of the fastener 12 and/or may be a material disposed on the inner surface of the fastener 12. For example, the gripping surface 12g of the fastener 12 may be corrugated and/or it may be lined with a material having gripping characteristics, such as rubber, silicon, an adhesive, and any other material, now know or later developed, in accordance with this invention. As mentioned above, the gripping surface 12g may be employed as a ratchet and teeth locking mechanism.

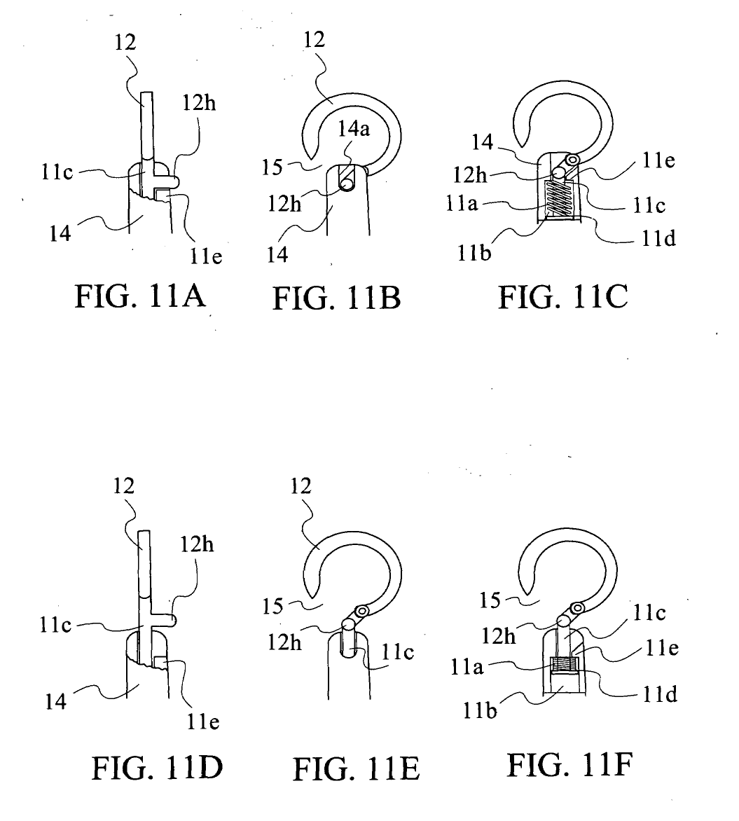

FIGS. 11A, 11B, 11C, 11D, 11E and 11F illustrate yet another embodiment for the fastener 12. In FIGS. 11A, 11B, 11C, 11D, 11E and 11F, the fastener 12 includes a biased element which is provided to secure the fastener 12 in a closed position. For exemplary purposes, a spring 11 a is provided as the biasing element.

FIGS. 11A, 11B and 11C demonstrate the fastener 12 in a closed position in which the fastener 12 is retracted within a portion of the first link 14. The opening 15 of the fastener 12 is substantially minimized and biased by the spring 11 a into a closed position so that when the fastener 12 is secured to the rearview mirror bracket 28, the fastener 12 is biased by the spring 11a to grip the rearview mirror bracket 28.

The fastener 12 includes a protrusion 12h by which a user may use their finger to extend or retract the fastener 12 into and out of a slot 14a in the first link 14. The fastener 12 also includes a stem 11c with a stem base 11d that is disposed within an open space 11b of the first link 14. The spring 11a is disposed around the stem 11c and has a first end butt up against the stem base 11d and a second end butt up against a collar portion 11e formed within the first link 14.

In operation, the user may extend the fastener 12 open by placing their thumb against the protrusion 12h and pushing the fastener 12 upward out of first link 14 against the biased force of the spring 11 a until the opening 15 of the fastener 12 is sufficiently enlarged (as shown in FIGS. 11D, 11E and 11F) to receive the rearview mirror bracket 28 of the interior rearview mirror 20. When the rearview mirror bracket 28 is received within the fastener 12, the user may release the fastener 12 so that the rearview mirror bracket 28 may be gripped as the spring 11a biases the stem base 11d of the fastener 12 back into the open space 11b within the first link 14 as shown in FIGS. 11A, 11B and 11C. It is to be understood that any method for securing the fastener 12 to the rearview mirror bracket 28 may be used that is now know, or later discovered, in accordance with this invention.

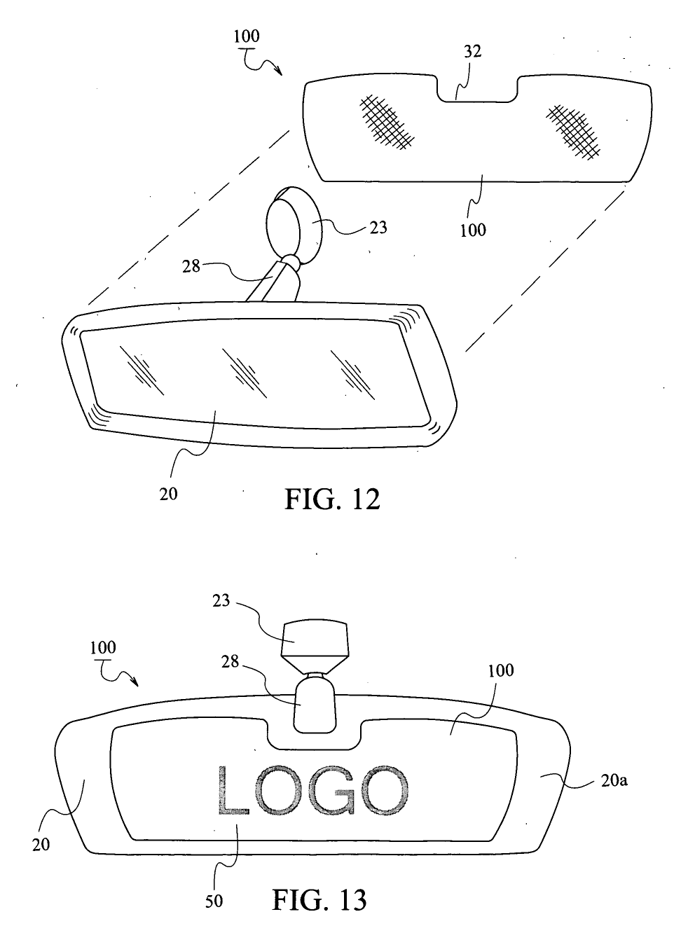

FIGS. 12 through 19 show various configurations for an alternative interior rearview mirror device 100 attached to an interior rearview mirror 20. As shown in each of the various embodiments, the interior rearview mirror device 100 is generally shaped to conform to a back side and forward facing portion of the interior rearview mirror interior rearview mirror 20. The interior rearview mirror device 100 may be contoured to fit around a rearview mirror bracket 28 that affixes the interior rearview mirror 20 to a front windshield 30 of a vehicle.

FIGS. 12 and 13 illustrate a first exemplary embodiment for the interior rearview mirror device 100 according to another aspect of the invention. The interior rearview mirror device 100 is generally shaped to conform to within peripheral edges of a back side of the interior rearview mirror 20. As shown, the interior rearview mirror device 100 includes a recess portion 32 to allow room for the rearview mirror bracket 28. In operation, the interior rearview mirror device 100 is secured to the forward facing surface 20a of the interior rearview mirror 20.

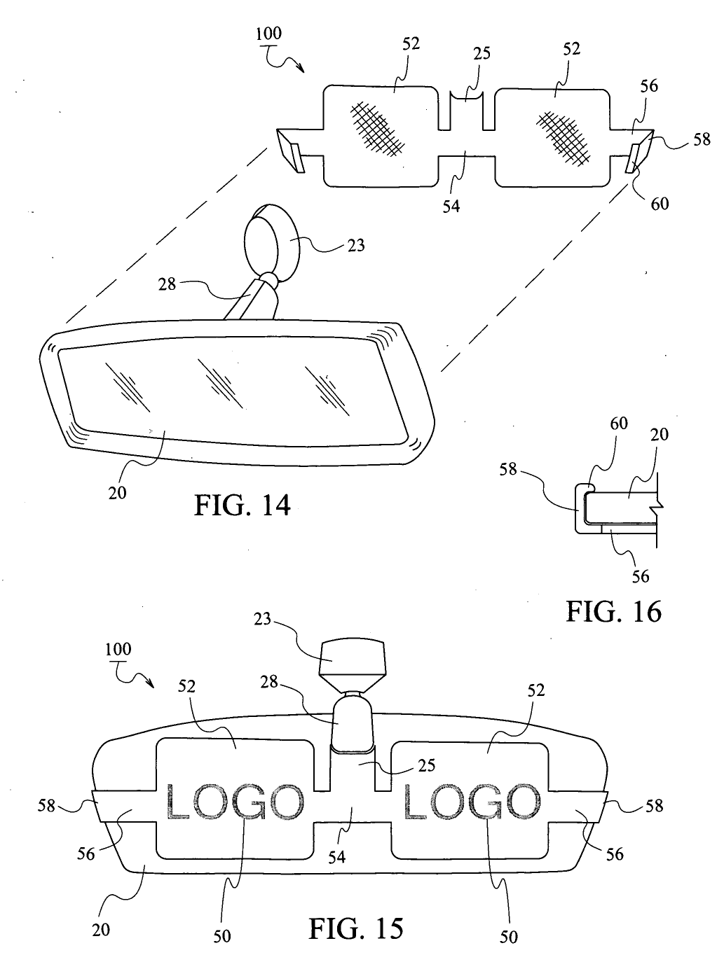

The interior rearview mirror device 100 may be secured to the interior rearview mirror 20 in a variety of ways. One method would be to provide an adhesive to the back side of the interior rearview mirror device 100 that lies adjacent to the interior rearview mirror 20. The adhesive may be glue, a polymer, rubber, cement and/or any other type of material used for providing adhesion from one surface to another within the scope of this invention. In the alternative, the interior rearview mirror device 100 may be fastened to the interior rear view mirror 20 with at least one adjustable strap 56 as will be described in FIGS. 14 through 15.

As mentioned before, the indicia 50 may be disposed on a front surface of the interior rearview mirror device 100 facing outward toward the front of a vehicle and/or may be provided backward facing into the cabin of the vehicle. Any type of indicia 50 may be displayed on the interior rearview mirror device 100. The indicia 50 may include, for example, a trademark, a service mark, a name, an emblem, a logo, a banner, an advertisement and/or any other type of indicia. The user can place indicia 50 to support their favorite business, university, school, local establishment, military, hobbies, special interests, and the like.

FIGS. 14 and 15 illustrate another embodiment for attaching an interior rearview mirror device 100 to an interior rearview mirror 20 according to this invention. As shown, the interior rearview mirror device 100 may be configured to include an alignment mounting portion 25 to provide alignment of the interior rearview mirror device 100 to the rearview mirror bracket 28 and to provide additional support to the interior rearview mirror device 100.

The interior rearview mirror device 100 illustrates indicia 50 configured as a pair of logos portions 52 disposed on both sides of the rearview mirror bracket 28. The pair of logo portions 52 are connected by a central portion 54. The alignment mounting portion 25 of the interior rearview mirror device 100 extends from the central portion 54 upward in alignment with the rearview mirror bracket 28. A pair of adjustable fastening straps 56 extend from each of the logo portions 52 to a peripheral side end of the interior rearview mirror 20.

Since interior rearview mirrors 20 come in different sizes and shapes, the adjustable fastening straps 56 may be extended and retracted to fit the various size interior rearview mirrors 20. As shown, more than one adjustable strap 56 may be utilized to secure the interior rearview mirror device 100 to the interior rearview mirror 20. At the peripheral end of the adjustable straps 56, a catch 58 may be disposed to secure the interior rearview mirror device 100 to the interior rearview mirror 20. Numerous types of catches may be employed to secure the interior rearview mirror device 100 to the interior rearview mirror 20, such as for example, hooks, straps, clips, Velcro, buckles, snaps, and the like.

As shown in 14, 15 and 16, the fastening straps 56 are attached to catches 58 which include a lip 60 for securing the fastening straps 56 of the interior rearview mirror device 100 to the interior rearview mirror 20. The fastening straps 56 may be composed of a variety of different materials including, but not limited to, an elastic, rubber and/or any other resilient material that may stretch to secure the catches 58 to the edges of the interior rearview mirror 20.

According to this embodiment, the interior rearview mirror device 100 may be composed of a flexible material that can be stretched across the length of the interior rearview mirror 20 to assist in appropriately sizing to the interior rearview mirror device 100. In use, the indicia 50 affixed to the interior rearview mirror device 100 may be viewed through the front windshield of the vehicle.

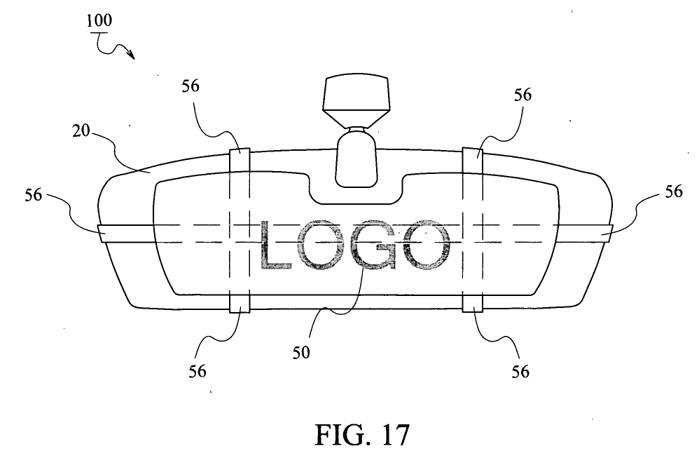

FIG. 17 illustrates another exemplary embodiment in which a plurality of fastening straps 56 are used to align and secure the interior rearview mirror device 100 to the interior rearview mirror 20. The fastening straps 56 may be disposed anywhere on the interior rearview mirror device 100 to secure it to the interior rearview mirror 20. As shown, the fastening straps 56 may span across (and/or within) the entire interior rearview mirror device 100 and/or may be affixed only at the edges of the interior rearview mirror device 100 to the periphery of the interior rearview mirror 20.

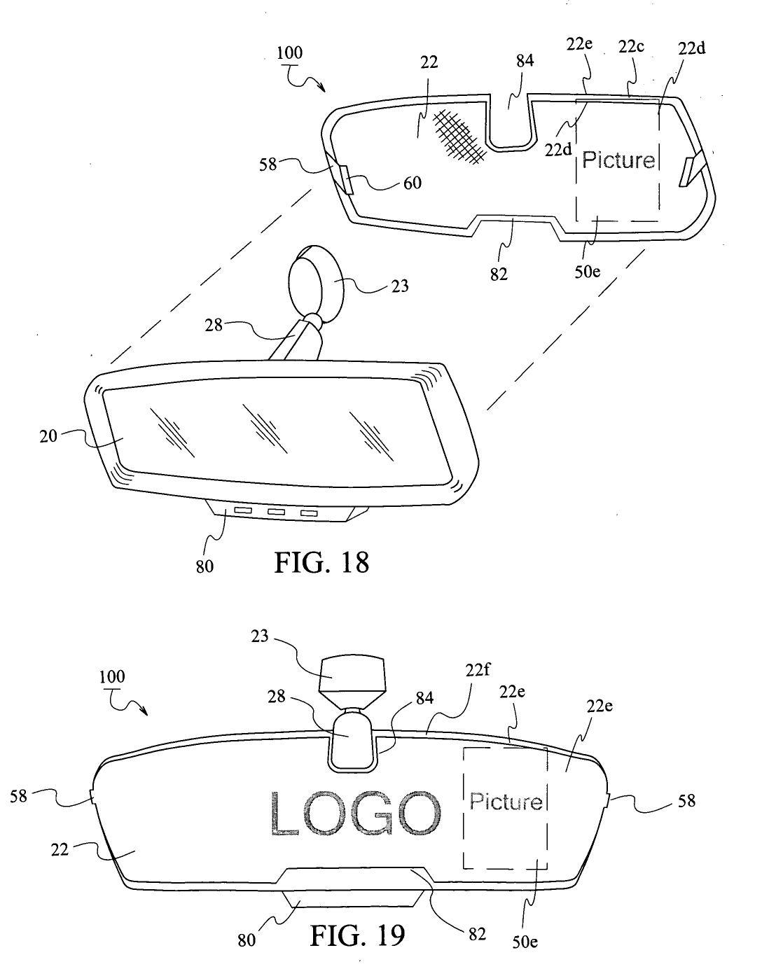

FIGS. 18 and 19 illustrate yet another embodiment for the interior rearview mirror device 100. According to this embodiment, the interior rearview mirror 20, includes an electronic unit 80. The electronic unit 80 may include circuitry for various features and functionality, for example, a dimmer switch, a garage door opener, or the like.

For vehicles including the electronic unit 80, the interior rearview mirror device 100 may be contoured to fit around the electronic unit 80 so as not to interfere with the functions and features of the electronic unit 80. The interior rearview mirror device 100 may be designed so that it does not cover a receiving light sensor in the electronic unit 80. For example, the interior rearview mirror device 100 may include a cut-out portion 82 designed to allow unobstructed access to the electronic unit 80.

The interior rearview mirror device 100 is formed as a substantially thin flat base that is flexible and follows the contour of the back side of an interior rearview mirror 20. The interior rearview mirror device 100 allows for minimal coverage and maximum light exposure. In the alternative, the interior rearview mirror device 100 may be made from a translucent material to allow for the passage of light into the illumination sensor with the electronic unit 80.

FIGS. 18 and 19 also show a bracket cut-out 84 portion in the interior rearview mirror device 100 into which the rearview mirror bracket 28 may be aligned and secured. The interior rearview mirror device 100 includes catches 58 which include a lip 60 for securing the interior rearview mirror device 100 to the interior rearview mirror 20. According to this embodiment, the interior rearview mirror device 100 is contoured to substantially cover the backward facing surface 20a of the interior rearview mirror 20.

In the alternative, the display panel 22 shown in FIGS. 18 and 19 may be configured as a sleeve 22c into which a photo 50e may be inserted. As shown. The sleeve 22c includes a first sleeve side 22d and a second sleeve side 22e. An image may be placed inside of sleeve opening 22f and secured between the first sleeve side 22d and the second sleeve side 22e. In this manner, the user can personalize the display panel 22 as they so desire by placing any type of indicia, such as an image of a child, a logo, and the like. Although the photo sleeve configuration is shown as part of this embodiment of FIGS. 18 and 19, the photo sleeve configuration may be incorporated into any of the embodiments described herein.

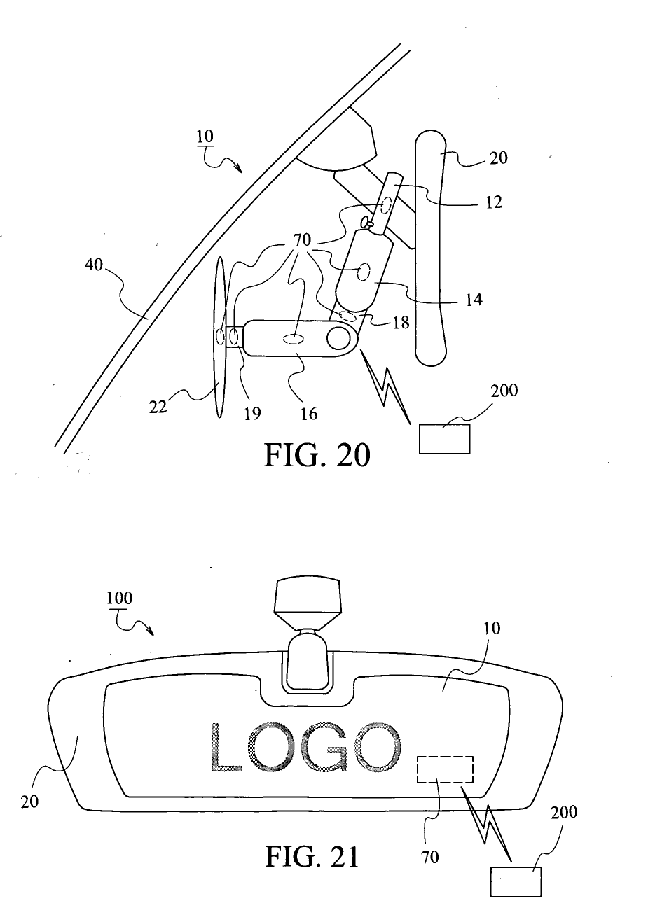

FIGS. 20 and 21 illustrate interior vehicle rearview mirror devices 10, 100 for displaying indicia embedded with at least one access element 70 according to this invention. The access element 70 may include various types of devices capable of providing verification, authentication and access that are currently known or later developed. For example, the access element 70 may be a magnetic strip, a bar code, a near field technology element, an RF transponder, and/or any other method for sending and receiving information to and from a processor 200 in an electronic control unit and the access element 70.

FIGS. 20 and 21 show that the access element 70 may be disposed anywhere on the rearview mirror devices 10, 100. As shown, the access element 70 may be disposed within the fastener 12, the first link 14, the first positioning device 18, the second link 16, the second positioning device 19, the display panel 22 and/or on any component of the rearview mirror devices 10, 100.

The access element 70 may be implemented for any number of various purposes. For example, at an athletic sporting event, the rearview mirror devices 10, 100 with the access element 70 may provide entry to the event or the parking lot to the event on the particular day that the event is scheduled. After the event has concluded, access to the event parking lot may be disabled and the rearview mirror devices 10, 100 may be used as a display memento in support of the particular team displayed by the indicia 50 on the rearview mirror devices 10, 100.

Alternatively, the rearview mirror devices 10, 100 with the access element 70 may be programmed as a season parking pass which will enable access throughout an entire sporting event season or the like. It would only then be necessary to provide one access element 70 as a season pass and not a parking pass and an event ticket for entrance for each game day. Security personnel can verify proper access to the event by swiping a reader over the interior rearview mirror device 10 embedded with the access element 70 and reading and verifying proper admittance for that particular day.

In addition, if an RF transponder or near field technology element is integrated as the access element 70, an arm to the parking lot gate may be opened only if access for that particular day could be verified and approved by an RF receiving device attached to the processor 200.

In operation, the access element 70 will function at least in the following manner. For example, when a vehicle with the interior rearview mirror device 10 approaches a secure location, a verification routine will be initiated once the interior rearview mirror device 10 has been detected by a receiving element including the processor 200. Information embedded in the interior rearview mirror device 10 will be transmitted to the receiving element and the processor will authenticate and verify whether the interior rearview mirror device 10 shall be granted access. Once the processor 200 has verified the status of the information received, the user of the interior rearview mirror device 10 may be granted access. Access may be in the form of raising an arm blocking the entrance to a parking location and/or unlocking the turn-style at an entrance to an event location.

According to this invention, the processor 200 may be implemented at various elements of the rearview mirror devices 10, 100. The processor 200 may be implemented in association with, and/or as part of, the various access technologies used for authenticating and granting access to the access element 70, and/or in association with the various elements of the rearview mirror devices 10, 100. The processor 200 may be implemented as a programmed general purpose computer, on a special purpose computer, a programmed microprocessor or micro-controller and peripheral integrated circuit elements, an ASIC or other integrated circuit, a digital signal processor, a hardwired electronic or logic circuit such as a discrete element circuit, a programmable logic device such as a PLD, PLA, FPGA or PAL, or the like. In general, any device processor capable of implementing the therapeutic functions shown in the figures can be used according to this invention. The particular form taken for the processor 200 is a design choice and will be obvious and predicable to those skilled in the art.

The processor 200 may be associated with a storage unit (not shown) using any appropriate combination of alterable, volatile or non-volatile memory or non-alterable, or fixed, memory. The alterable memory, whether volatile or non-volatile, can be implemented using any one or more of static or dynamic RAM, a floppy disk and disk drive, a write-able or rewrite-able optical disk and disk drive, a hard drive, flash memory or the like. Similarly, the non-alterable or fixed memory can be implemented using any one or more of ROM, PROM, EPROM, EEPROM, an optical ROM disk, such as a CD-ROM or DVD-ROM disk, and disk drive or the like.

The processor 200 of the interior rearview mirror devices 10, 100 is programmable and can be adapted to provide instruction to the rearview mirror devices 10, 100. The processor 200 is programmable and may be programmed provide instructions for access limitations to a particular area in accordance with this invention.

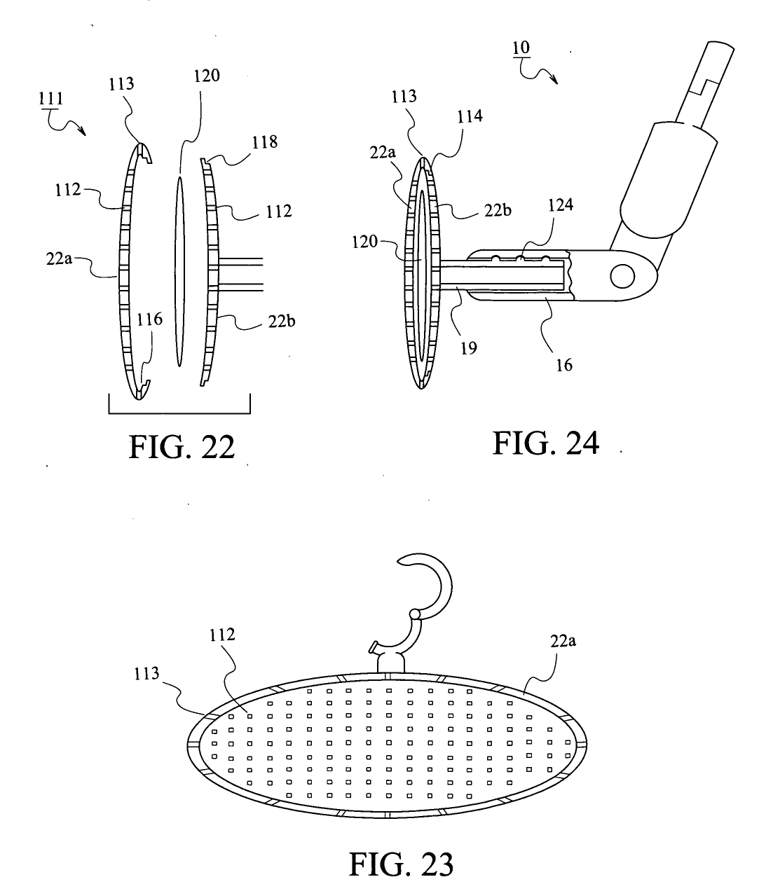

FIG. 22 shows an exploded view for an air freshener display panel 111 in accordance with another aspect of this invention. In FIG. 22, the air freshener display panel 111 includes a front side 22a, a back side 22b and an air freshener 120. The front side 22a of the air freshener display panel 111 is attached to the back side 22b by a closure mechanism 114. The closure mechanism 114 includes a first closure connecting portion 116 that fastens to a second closure connecting portion 118. The closure mechanism 114 may be configured in a number of different ways in accordance with this invention.

FIGS. 23 and 24 illustrate an exemplary illustration of the through perforations 112 and radial perforations 113 disposed on the air freshener display panel 111. The air freshener 120 may be used to sanitize the air, neutralize odor, or simply refresh the surrounding area of an undesirable order. The air freshener 120 may be employed with a dual purpose for eliminating the source of an odor while leaving a clean scent in its place. The air fresheners 120 may be embodied as a fragrance that permits a predetermined amount of fragrance to emanate through various perforations 112, 113 in the 111.

In particular, FIGS. 22 through 24 show a plurality of through perforations 112 and a plurality of radial perforations 113 through which the scent of the air freshener 120 may emanate into the adjacent atmosphere. The perforations 112,113 may be selectively designed to allow more or less air freshener 120 to emanate through the various perforations 112, 113. Alternatively, and not shown, the air freshener 120 may be dispensed as a spray or a puff of fragrance in which a push-button mechanism may cause the air freshener to be dispensed through the various perforations 112, 113.

Various types of aromatic fragrance materials may be used in combination with this invention and placed within the air freshener display panel 111, including, but not limited to, scented, materials, waxy materials, potpourri, gels, a variety of synthetic fragrance components, such as aldehydes, ketones, esters, alcohol, terpenes, and any other fragrance that is now known or later developed in accordance with this invention.

Referring back to FIGS. 12 and 13, the interior rearview mirror device 100 may be made of an air freshening 120 material. The interior rearview mirror device 100 may be attached to the air freshener display panel 111 in a variety of different ways, including Velcro, an adhesive or the like. According to this embodiment, the interior rearview mirror device 100 is composed of the air freshening 120 material.

FIG. 24 further illustrates the air freshener display panel 111 may be configured to be easily detached from the remainder of the rearview mirror device 10. Positioning device catches 124 are shown disposed on the second positioning device 19 portion to optimally arrange the indicia 50 at a preferred position within the second link 16.

It will be recognized by those skilled in the art that changes or modifications may be made to the above described embodiment without departing from the broad inventive concepts of the invention. It is understood therefore that the invention is not limited to the particular embodiment which is described, but is intended to cover all modifications and changes within the scope and spirit of the invention.

What is claimed:

1. An indicia displaying interior vehicle rearview mirror device comprising:
a display panel fastened via a linkage to a rearview mirror, wherein at least one side of the display panel includes forward facing indicia being displayed thereon.

2. The indicia displaying interior vehicle rearview mirror device according to claim 1, wherein the linkage includes at least one positioning device, a link and a fastener that is adjustably fastened to a rear view mirror.

3. The indicia displaying interior vehicle rearview mirror device according to claim 2, wherein the positioning device may be selected from at least one of: a pivot, a telescopic extension, a swivel and a universal joint so that the display panel can be positioned in a number of preferred positions.

4. The indicia displaying interior vehicle rearview mirror device according to claim 1, wherein the display panel is detachable from the interior vehicle rearview mirror device.

5. The indicia displaying interior vehicle rearview mirror device according to claim 1, wherein the display panel is an air freshener.

6. The indicia displaying interior vehicle rearview mirror device according to claim 1, wherein the display panel comprises:
a front side that can be detached from a back side, into which is defined a housing for storing an air freshening substance.

7. The indicia displaying interior vehicle rearview mirror device according to claim 6, wherein the display panel includes a plurality of perforations through which the odor from the air freshener may emanate.

8. The indicia displaying interior vehicle rearview mirror device according to claim 1, further comprising an embedded access element that communicates information wirelessly to and/or from a receiving element to permit access.

9. The indicia displaying interior vehicle rearview mirror device according to claim 2, wherein the fastener is adjustably secured to a bracket of rearview mirror.

10. The indicia displaying interior vehicle rearview mirror device according to claim 9, wherein the fastener is configured as at least one of: a hook, a pivoting claw and a hook that is biased closed.

11. The indicia displaying interior vehicle rearview mirror device according to claim 1, wherein the display panel and the linkage are integral as a single unit.

12. An interior vehicle rearview mirror device comprising:
a flat elongated base having a front surface and a back surface,
wherein the back surface is attached to a forward facing portion of a rearview mirror and wherein the flat elongated base includes indicia displayed therein.

13. The interior vehicle rearview mirror device according to claim 12, wherein the indicia is disposed in a sleeve formed between the front surface and the back surface of the flat elongated base.

14. The interior vehicle rearview mirror device according to claim 12, wherein at least one adjustable strap fastens the flat elongated base to the rear view mirror.

15. The interior vehicle rearview mirror device according to claim 14, wherein the adjustable strap includes a clasp that is secured to an edge of the rearview mirror.

16. The interior vehicle rearview mirror device according to claim 12, wherein flat elongated base includes an alignment mounting portion for positioning the interior vehicle rearview mirror device on the rearview mirror.

17. The interior vehicle rearview mirror device according to claim 12, wherein flat elongated base includes a recess for positioning the interior vehicle rearview mirror device adjacent to the rearview mirror.

18. The interior vehicle rearview mirror device according to claim 12, wherein the interior vehicle rearview mirror device is an air freshener.

19. The interior vehicle rearview mirror device according to claim 12, further comprising an embedded access element selected from at least one of: a magnetic strip, a bar code, an RF element and a transponder.

20. A method for gaining access to a secure location comprising;
triggering an access verification routine;
transmitting information embedded in an access element of a vehicle rearview mirror device to a remote processor;
verifying the information transmitted; and
granting access to the secure location.
